(19) United States
(12) Patent Application Publication
(10) Pub. No.: US 2007/0037031 A1
(43) Pub. Date: Feb. 15, 2007

(54) CERMET AND CERAMIC INTERCONNECTS FOR A SOLID OXIDE FUEL CELL

(75) Inventors: Mark Cassidy, St. Andrews (GB); K.R. Sridhar, Los Gatos, CA (US); Dien Nguyen, San Jose, CA (US); Patrick Munoz, Milpitas, CA (US)

Correspondence Address: FOLEY AND LARDNER LLP;SUITE 500, 3000 K STREET NW, WASHINGTON, DC, 20007, US

(73) Assignee: ION AMERICA CORPORATION

(21) Appl. No.: 11/457,016

(22) Filed: Jul. 12, 2006

Related U.S. Application Data
(60) Provisional application No. 60/698,468, filed on Jul. 13, 2005.
(60) Provisional application No. 60/809,395, filed on May 31, 2006.

(51) Int. Cl. H01M 8/12; H01M 8/02; C04B 35/00; C04B 35/64

(52) U.S. Cl. 429/32; 429/34; 501/95.2; 501/95.3; 264/618

(57) ABSTRACT

An interconnect and gas separator for a solid oxide fuel cell includes a cermet material comprising a first conductive phase and a second ceramic phase or a multi-component ceramic material including a first ceramic ionically conductive and electrically non-conductive component and a second ceramic electrically conductive component.

This application claims benefit of priority of U.S. Provisional Application Ser. Nos. 60/698,468, filed on Jul. 13, 2005 and 60/809,395 filed on May 31, 2006 which are incorporated herein by reference in their entirety.

### BACKGROUND OF THE INVENTION

The present invention relates generally to fuel cell components and specifically to cermet and ceramic interconnects for solid oxide fuel cells.

Fuel cells are electrochemical devices which can convert energy stored in fuels to electrical energy with high efficiencies One type of high temperature fuel cell is a solid oxide fuel cell which contains a ceramic (i.e., a solid oxide) electrolyte, such as a yttria stabilized zirconia (YSZ) electrolyte, One component of a planar solid oxide fuel cell stack or system, is the so called gas separator plate that separates the individual cells in the stack. The gas separator plate separates fuel, such as hydrogen or a hydrocarbon fuel, flowing to the anode of one cell in the stack from oxidant, such as air, flowing to a cathode of an adjacent cell in the stack. Frequently, the gas separator plate is also used as an interconnect which electrically connects the anode electrode of one cell to a cathode electrode of the adjacent cell. In this case, the gas separator plate which functions as an interconnect is made of an electrically conductive material. This gas separator plate preferably has the following characteristics: it does not conduct ions, it is non-permeable to the fuel and oxidant, it is chemically stable in both the fuel and oxidant environment over the entire operating temperature range, it does not contaminate either the electrodes or the electrolyte, it is compatible with the high temperature sealing system, it has a Coefficient of Thermal Expansion (CTE) that closely matches that of the selected electrolyte, and it has a configuration that lends itself to low cost at high volumes.

In the prior art, gas separator plates which function as interconnects have been developed using tailored metal alloys and electrically conductive ceramics. These approaches have not been completely satisfactory. The tailored metal alloy approach meets all the desired characteristics except that it is limited to a matching CTE that is only within about 10% of the solid oxide electrolyte. A more closely matched CTE can be accomplished by sacrificing the chemical compatibility of the interconnect with the electrodes/electrolyte. As a result of this CTE limitation, the area of the cell is limited in order to avoid stressing the electrolyte beyond its capability. Additionally, the seals are more difficult to be reliably produced and the electrolyte thickness must be proportionally thicker to have the strength to counteract the minor CTE mismatch.

There are two types of prior art ceramic gas separator plate interconnects. The first type uses an electrically conductive ceramic material. However, these electrically conductive ceramics are expensive and difficult to fabricate, their chemical compatibility with the electrodes is lower than desired and the CTE mismatch of these ceramics with the electrolyte remains higher than desired.

The second type of ceramic gas separator plate comprises a CTE matched, non-electrically conductive ceramic material with multiple through vias filled with an electrically conductive material. This approach solves the CTE mismatch, the chemical incompatibility and the high volume cost difficulty problems of the first type of ceramic separator plate. However, this configuration is susceptible to undesirable cross interconnect reactant permeability (i.e., leakage of the fuel and oxidant through the separator plate).

### SUMMARY OF THE INVENTION

According to an embodiment of the invention, an interconnect and gas separator for a solid oxide fuel cell includes a cermet material comprising a first conductive phase and a second ceramic phase.

According to another embodiment of the invention, a method of making a cermet interconnect for a solid oxide fuel cell stack comprises forming a high solids loading dough from a mixture of ceramic and metal particles, forming the high solids loading dough into high green density compact by pressing or rolling, and firing at a temperature of from about 900 to about 1000° C. to form the interconnect for a solid oxide fuel cell stack.

According to another embodiment of the invention, a multi-component ceramic material comprises a first ceramic ionically conductive and electrically non-conductive component and a second ceramic electrically conductive component.

### BRIEF DESCRIPTION OF THE DRAWINGS

FIGS. 1 and 2 are schematic side cross sectional views of a solid oxide fuel cell stack incorporating the interconnect of embodiments of the present invention.

### DETAILED DESCRIPTION OF PREFERRED EMBODIMENTS

In a first embodiment of the invention, the interconnect for a solid oxide fuel cell comprises a cermet material. An interconnect for a solid oxide fuel cell comprising a gas separator plate made from a CTE matched, electrically conductive but ionically non-conductive cermet material but without vias extending through the gas separator plate, reduces or eliminates the undesirable cross interconnect reactant permeability (i.e., leakage of the fuel and oxidant through the separator plate) and still meets all of the other desired characteristics of a functional interconnect. The dense cermet interconnect contains a continuous percolating electrically conductive network or phase on a microstructural scale in a host ceramic phase which is ionically non-conductive, instead of macroscopic discrete conducting tracks inside the ceramic plate of the prior art.

The use of a cermet interconnect has several advantages compared to the prior art configurations. It should be noted that these advantages are illustrative only and should not be considered limiting on the scope of the claims. The gas separator plate can be used as an interconnect without including vias that extend through the entire gas separator plate. The gas separator plate is made from a non-ionically but electrically conductive cermet material which is CTE matched to the solid oxide fuel cell electrolyte material without increased cross interconnect reactant permeability. This also allows the active area of the individual cells to be increased to further decrease costs and to simplify the fuel cell stack sealing configuration. Additionally, thinner and/or lower strength electrolytes can be used with a CTE matched cermet gas separator plate, thus increasing the power density of the cells which also leads to a lowering of costs per kW. Furthermore, when the cermet gas separator plate material has a CTE that is within about 1% of the solid oxide electrolyte material, it greatly increases the ability to rapidly thermally cycle the solid oxide stack.

The following preferred embodiments of the cermet interconnect should not be considered to be limiting on the scope of the claims.

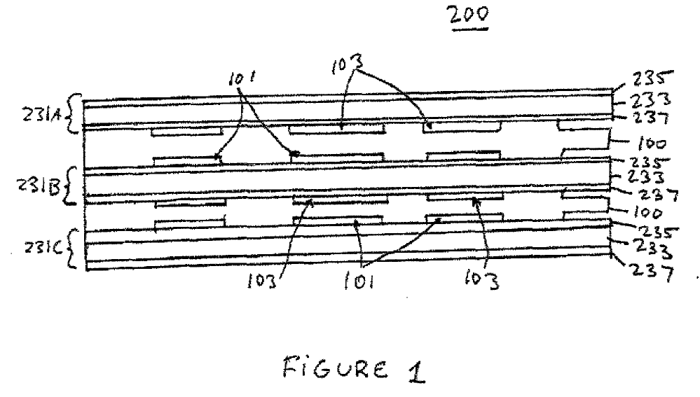

FIG. 1 illustrates a solid oxide fuel cell stack 200 incorporating a plurality of cermet interconnects 100 and a plurality of solid oxide fuel cells 231. Each solid oxide fuel cell 231 comprises a plate shaped fuel cell comprising a ceramic electrolyte 233, an anode 235 located on a first surface of the electrolyte and a cathode 237 located on a second surface of the electrolyte. The fuel cells also contain various contacts, seals and other components which are omitted from FIG. 1 for clarity.

Each interconnect 100 shown in FIG. 1 is located between adjacent fuel cells 231 in the stack, Each interconnect 100 is electrically connected to an adjacent cathode 237 of a first adjacent fuel cell 231A and to an adjacent anode 235 of a second adjacent fuel cell 231B, such that each interconnect 100 electrically connects a cathode 237 of a first fuel cell 231A and an anode 235 of an adjacent second fuel cell 231B. If cathode and anode contact pads are present, then these pads are located in electrical contact with and between the interconnect and the respective electrodes 237, 235 of the fuel cells 231. It should be noted that the stack 200 shown in FIG. 1, may be oriented upside down or sideways from the exemplary orientation shown in FIG. 1. Furthermore, the thickness of the components of the stack 200 is not drawn to scale or in actual proportion to each other, but is magnified for clarity.

The interconnect/gas separator plate 100 preferably contains gas flow grooves 101, 103 (i.e., fuel and oxidizer gas flow grooves, respectively) located in the respective first and second major surfaces of the separator plate 100. The grooves 101, 103 may be parallel to each other as shown in FIG. 1. Alternatively, the grooves may be perpendicular to each other for cross gas flow on opposite sides of the gas separator plate. Of course, the grooves may extend in any direction between parallel and perpendicular from each other if desired.

Preferably the cermet interconnect/gas separator plate 100 comprises a cermet material having a coefficient of thermal expansion which differs by about one percent or less from a coefficient of thermal expansion of the ceramic electrolyte 233 material of the fuel cells 231. In other words, the interconnect/separator plate is made of a cermet material which is CTE matched to the material of the ceramic electrolyte.

While any suitable materials may be used, preferably, the electrolyte 233 comprises any suitable stabilized zirconia, such as yttria and/or scandia stabilized zirconia, and the interconnect/ceramic gas separator plate 100 comprises a cermet comprising a ceramic phase containing yttria and/or scandia stabilized zirconia and a conductive phase. The ceramic phase may also contain an amount of additional ceramic material, such as alumina, sufficient to render the cermet ionically non-conductive, but preferably not exceeding the amount which would render the interconnect/gas separator plate cermet material to be non-CTE matched with the fuel cell electrolyte. It should be noted that other materials may also be used. For example, ceramic materials other than alumina may be added to the yttria and/or scandia stabilized zirconia to render the cermet ionically non-conductive. Furthermore, doped ceria may be used as the electrolyte material and the interconnect ceramic phase instead of a stabilized zirconia. The materials are preferably selected such that the CTE of the interconnect/ceramic gas separator plate is matched to the CTE of the fuel cell electrolyte 233.

Any suitable material may be used for the conductive phase of the cermet interconnect. Preferably, the conductive phase comprises a continuous, percolating conductive network on a microstructural scale in a dense ceramic phase, such that the network provides an electrically conductive path from one major surface of the interconnect to the opposite major surface of the interconnect to connect the anode of one fuel cell to the cathode of the adjacent fuel cell in the stack. The dense ceramic phase encapsulates the majority of the conductive network, thus minimizing exposure of the conductive network to ambient atmospheres and therefore minimizing oxidation of the conductive network. The conductive phase may also be in the shape of whiskers and/or strands. The term whisker refers to elongated rod shaped bodies having a diameter of about one to ten microns, while the term strand refers to elongated rod shaped bodies having a diameter of about 10 microns to about 10 millimeters.

Preferably, a high melting temperature metal or alloy is used in the conductive phase. This high temperature metal or alloy is co-fired (i.e., co-sintered) with the ceramic phase. For example, chromium, nickel, other refractory metals and their alloys, such as high temperature nickel alloys, and conducting intermetallics such as, for example, nickel aluminide, may be used as the conductive phase. Work on the production of porous anode composites has shown that chromium showed little adverse reaction with zirconia. However, as that work was concerned with porous bodies, no mention was made about the detrimental effects of any vapor phase chromium oxides on the sintering of the ceramic. See Wilden, M., et al., Materials Chem. & Phys., Vol. 75, #1-3 (2002) page 276, incorporated by reference in its entirety.

If desired, an additional material which lowers the suitable fully dense sintering temperature of the cermet may be added to the cermet. For example, recent publications describing gadolinia doped ceria SOFC electrolytes have demonstrated that with the addition of small amounts of cobalt and other compounds it was possible to sinter the doped ceria fully dense at temperatures of 1000° C. and below. See Lewis, G. S., et al. “Sintering of Gadolinia-Doped Ceria at Reduced Temperature,” 2000; and Kleinlogel, C., et al., “Nano Sized Ceria Solid Solutions for Intermediate Temperature Solid Oxide Fuel Cells,” Electrochemical Society Proceedings, Vol. 99-19 1999, incorporated herein by reference in their entirety. Specifically, both references disclose that by mixing a metal nitrate, such as a cobalt, copper, nickel, manganese or iron nitrate with gadolinia doped ceria electrolyte material at 1 cat % each or greater, resulted in a dense ceramic (containing a metal oxide and gadolinia doped ceria phases) after being sintered at 1000° C. and below. Thus, any material, such as a metal nitrate, such as a cobalt, copper, nickel, manganese or iron nitrate, which lowers the cermet sintering temperature may be added to obtain a high density cermet, such as a fully dense cermet with a closed porosity (i.e., density of greater than 95%) by sintering at 1000° C. or below. Therefore, the interconnect cermet of an embodiment of the present invention would contain: i) the ceramic phase, which includes a first ionically conductive ceramic material, such as SSZ and/or YSZ, which is CTE matched to the fuel cell electrolyte, and a second ceramic material, such as alumina, which renders the ceramic phase ionically non-conductive; ii) the conductive phase comprising Ni, Cr, other refractory metals and their alloys, which provides an electrically conductive path from one major surface of the interconnect to the opposite major surface of the interconnect; and optionally iii) a small amount of a material which lowers the fully dense sintering temperature of the cermet to 1000° C. or below, such as cobalt, copper, etc. The amount of the conductive phase in the cermet depends on the type of metal and ceramic being used and can be optimized to obtain the best combination of electrical conductivity and CTE matching to the fuel cell electrolyte.

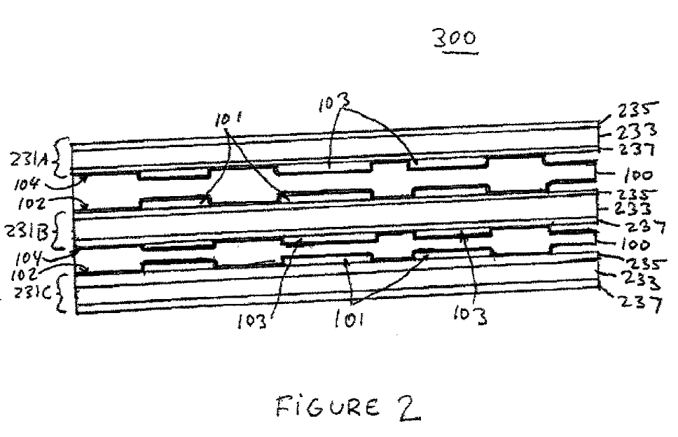

In a second embodiment of the invention, the interconnect includes one or more optional electrically conductive barrier layers which protect the conductive phase of the cermet from the ambient atmosphere (i.e., from the process gases) and which reduce or prevent oxidation of the conductive phase. For example, as shown in FIG. 2, the interconnect 100 of stack 300 may have a first barrier layer 102 on a first side of the interconnect that electrically contacts an anode 235 of an adjacent fuel cell, and a second barrier layer 104 on a second side of the interconnect that electrically contacts a cathode 237 of another adjacent fuel cell. The interconnect may contain either one of the barrier layers 102, 104 or both barrier layers 102, 104. The barrier layers are preferably dense and gas impermeable. The barrier layers are preferably sufficiently thin so as not to disrupt the CTE matching between the fuel cell electrolyte and the interconnect. For example, the barrier layers may be less than 10 microns thick, such as about 1 to about 10 microns thick, such as about 5 microns thick. The barrier layers may be made of any electrically conductive material which is compatible with the adjacent fuel cell electrodes and electrode contact layers. For example, the first barrier layer 102 may comprise nickel or a high temperature nickel alloy, while the second barrier layer 104 may comprise an electrically conductive ceramic, such as LSM.

In a third embodiment of the invention, the conductive phase of the interconnect/gas separator comprises an electrically conductive ceramic material. Examples of this material include perovskite ceramic materials, such as lanthanum strontium manganite (LSM) and lanthanum strontium chromite (LSC). In this embodiment, the interconnect/gas separator comprises a multi-component ceramic material rather than a cermet. In other words, the interconnect may comprise a three component or a three phase ceramic material comprising: i) the CTE matched ceramic component, which includes an ionically conductive ceramic material, such as SSZ and/or YSZ, which is CTE matched to the fuel cell electrolyte, ii) the electrically conductive ceramic component comprising the electrically conductive ceramic component, such as LSM or LSC, and iii) an ionically non-conductive ceramic component, such as alumina, which renders the multi-component ceramic material ionically non-conductive. The ionically non-conductive ceramic component may be omitted in case the electrically conductive component material is selected such that it renders the multi-component ceramic material ionically non-conductive. The electrically conductive ceramic component may comprise a continuous percolating conductive network on a microstructural scale in the ionically conductive ceramic component and/or the electrically conductive ceramic component may comprise whiskers and/or strands. If desired, the conductive component of the interconnect may include both the metal phase of the first embodiment and the electrically conductive ceramic of the third embodiment.

The cermet interconnect of the first embodiment may be formed by any suitable cermet fabrication method. For example, the cermet may be formed by forming a high solids loading dough from an intimate mixture of ceramic and metal particles (and/or from a mixture of ceramic particles and metal whiskers or strands) and forming this high solids loading dough into high green density compact by, for example, pressing or rolling routes. Non-noble metals are preferred. However, noble metals may also be used. The high density green compact is then fired at a temperature of for example, from about 900 to about 1000° C. to form a cermet interconnect body. The compact may be fired in any suitable ambient, such as in air. Alternatively, the compact may be fired in an inert ambient, such as in a nitrogen or a noble gas ambient, or in a reducing ambient, such as in a forming gas or a hydrogen ambient, to decrease the oxidation of metal particles. In contrast to a conductive ceramic, such as LSM, which has a one phase structure, the cermet has a two phase structure. It is noted that the as-fired cermet contains a metal phase, such as nickel or chromium, and a ceramic phase, such as a stabilized zirconia. The formation of microcracks between the ceramic and metallic phases due to mismatched coefficients of thermal expansion may be decreased or eliminated, both with respect to processing and operational behavior, by optimization of phase distribution which can be manipulated by variations in component particle size distribution and volumetric ratio. The barrier layers 102, 104 of the second embodiment may be formed on the interconnect either before and/or after the interconnect firing step by any suitable layer deposition methods. The multi-component ceramic interconnect of the third embodiment may be made by any suitable ceramic fabrication method, such as by mixing different ceramic particles (and/or by mixing stabilized zirconia particles and conductive ceramic whiskers or strands) in a high solids loading dough followed by the compacting and the firing steps.

Combining the above described method(s) with one of the methods for forming a compliant contact disclosed in currently pending U.S. patent application Ser. No. 10/369,133 and thereby minimizing any required flatness and/or surface finish tolerances, will create a very cost effective method of producing the interconnect. The entire disclosure of currently pending U.S. patent application Ser. No. 10/369,133 is hereby incorporated by reference in its entirety, including the specification, drawings, abstract and claims. Furthermore, the disclosure of currently pending U.S. patent application Ser. No. 10/822,707 is hereby incorporated by reference in its entirety, including the specification, drawings, abstract and claims.

The foregoing description has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

What is claimed is:

1. An interconnect and gas separator for a solid oxide fuel cell, comprising a cermet material comprising a first conductive phase and a second ceramic phase.

2. The interconnect of claim 1, wherein the conductive phase comprises at least one of whiskers, strands or a continuous percolating conductive network located in the ceramic phase.

3. The interconnect of claim 1 wherein the interconnect comprises a dense body having a closed pore structure and a density of greater than 95%.

4. The interconnect of claim 1, wherein the interconnect comprises a plate shaped interconnect which is electrically conductive but ionically not conductive.

5. The interconnect of claim 1, wherein the conductive phase of the cermet comprises a non-noble metal or alloy.

6. The interconnect of claim 5, wherein the conductive phase of the cermet comprises nickel, chromium, other refractory metals or their alloys.

7. The interconnect of claim 1, wherein the conductive phase of the cermet comprises an intermetallic.

8. The interconnect of claim 7, wherein the intermetallic comprises nickel aluminide.

9. The interconnect of claim 1, wherein the ceramic phase comprises at least one of (i) yttria stabilized zirconia or scandia stabilized zirconia and (ii) another ceramic material which renders the ceramic phase ionically non-conductive.

10. The interconnect of claim 1, further comprising at least one electrically conductive barrier layer located on at least one surface of the interconnect.

11. A solid oxide fuel cell stack, comprising:
a plurality of solid oxide fuel cells; and
a plurality of interconnects according to claim 1.

12. The stack of claim 11, wherein:
each solid oxide fuel cell comprises a plate shaped fuel cell comprising a ceramic electrolyte, an anode located on a first surface of the electrolyte and a cathode located on a second surface of the electrolyte;
each interconnect is plate-shaped and located between adjacent fuel cells in the stack;
each interconnect is electrically connected to an adjacent cathode of a first adjacent fuel cell; and
each interconnect is electrically connected to an adjacent anode of a second adjacent fuel cell, such that each interconnect electrically connects a cathode of the first adjacent fuel cell and an anode of the second adjacent fuel cell.

13. The stack of claim 11, wherein the ceramic phase of the interconnect cermet comprises the same material as the material of the fuel cell electrolyte and another ceramic material which renders the ceramic phase ionically non-conductive.

14. The stack of claim 11, wherein:
a ceramic phase of the interconnect cermet comprises a stabilized zirconia and alumina, and the fuel cell electrolyte comprises a stabilized zirconia; and
a CTE mismatch between the fuel cell electrolyte and the interconnect is 1% or less.

15. A method of making a cermet interconnect for a solid oxide fuel cell stack, comprising:
forming a high solids loading dough from a mixture of ceramic and metal particles;
forming the high solids loading dough into high green density compact by pressing or rolling; and
firing at a temperature of from about 900 to about 1000° C. to form the interconnect for the solid oxide fuel cell stack.

16. The method of claim 15, wherein the metal comprises a non-noble metal or alloy.

17. The method of claim 16, wherein the metal comprises nickel, chromium, another refractory metal or their alloys.

18. The method of claim 16, wherein the ceramic comprises a stabilized zirconia and another ceramic material which renders the interconnect ionically non-conductive.

19. The method of claim 16, further comprising adding a material which lowers a sintering temperature of the cermet to 1000° C. or less.

20. A solid oxide fuel cell stack containing a cermet interconnect produced by a process according to claim 15.

21. A fuel cell stack comprising a cermet interconnect made according to claim 20 and a plurality of solid oxide fuel cell stacks.

22. An interconnect and gas separator for a solid oxide fuel cell, comprising a multi-component ceramic material comprising a first ceramic ionically conductive and electrically non-conductive component and a second ceramic electrically conductive component.

23. A solid oxide fuel cell stack, comprising:
a plurality of solid oxide fuel cells; and
a plurality of interconnects according to claim 22.

24. The stack of claim 22, wherein the first component of the interconnect comprises the same material as the material of the fuel cell electrolyte.

25. The stack of claim 23, wherein:
the first component of the interconnect comprises a stabilized zirconia;
the second component of the interconnect comprises LSM or LSC; and
the fuel cell electrolyte comprises a stabilized zirconia.
